(19) United States
(12) Patent Application Publication
(10) Pub. No.: US 2017/0212840 A1
(43) Pub. Date: Jul. 27, 2017

(54) PROVIDING SCALABLE DYNAMIC RANDOM ACCESS MEMORY (DRAM) CACHE MANAGEMENT USING TAG DIRECTORY CACHES

(71) Applicant: QUALCOMM Incorporated, San Diego, CA (US)

(72) Inventors: Hien Minh Le, Cedar Park, TX (US); Thuong Quang Truong, Austin, TX (US); Natarajan Vaidhyanathan, Carrboro, NC (US); Mattheus Cornelis Antonius Adrianus Heddes, Raleigh, NC (US); Colin Beaton Verrilli, Apex, NC (US)

(21) Appl. No.: 15/192,019

(22) Filed: Jun. 24, 2016

Related U.S. Application Data
(60) Provisional application No. 62/281,234, filed on Jan. 21, 2016.

(51) Int. Cl. G06F 12/08

(52) U.S. Cl. CPC G06F 12/0873; G06F 12/0895; G06F 2212/1016; G06F 2212/305; G06F 2212/313

(57) ABSTRACT

Providing scalable dynamic random access memory (DRAM) cache management using tag directory caches is provided. In one aspect, a DRAM cache management circuit is provided to manage access to a DRAM cache in a high-bandwidth memory. The DRAM cache management circuit comprises a tag directory cache and a tag directory cache directory. The tag directory cache stores tags of frequently accessed cache lines in the DRAM cache, while the tag directory cache directory stores tags for the tag directory cache. The DRAM cache management circuit uses the tag directory cache and the tag directory cache directory to determine whether data associated with a memory address is cached in the DRAM cache of the high-bandwidth memory. Based on the tag directory cache and the tag directory cache directory, the DRAM cache management circuit may determine whether a memory operation can be performed using the DRAM cache and/or a system memory DRAM.

### PRIORITY CLAIM

The present application claims priority under 35 U.S.C. §119(e) to U.S. Provisional Patent Application Ser. No. 62/281,234 filed on Jan. 21, 2016 and entitled “PROVIDING SCALABLE DYNAMIC RANDOM ACCESS MEMORY (DRAM) CACHE MANAGEMENT USING TAG DIRECTORY CACHES,” the contents of which is incorporated herein by reference in its entirety.

### BACKGROUND

I. Field of the Disclosure

The technology of the disclosure relates generally to dynamic random access memory (DRAM) management, and, in particular, to management of DRAM caches.

II. Background

The advent of die-stacked integrated circuits (ICs) composed of multiple stacked dies that are vertically interconnected has enabled the development of die-stacked dynamic random access memory (DRAM). Die-stacked DRAMs may be used to implement what is referred to herein as “high-bandwidth memory,” which provides greater bandwidth than conventional system memory DRAM while providing similar access latency. High-bandwidth memory may be used to implement a DRAM cache to store frequently accessed data that was previously read from a system memory DRAM and evicted from a higher level system cache, such as a Level 3 (L3) cache as a non-limiting example. Providing a DRAM cache in high-bandwidth memory may reduce memory contention on the system memory DRAM, and thus, in effect, increase overall memory bandwidth.

However, management of a DRAM cache in a high-bandwidth memory can pose challenges. The DRAM cache may be orders of magnitude smaller in size than a system memory DRAM. Thus, because the DRAM cache can only store a subset of the data in the system memory DRAM, efficient use of the DRAM cache depends on intelligent selection of memory addresses to be stored. Accordingly, a DRAM cache management mechanism should be capable of determining which memory addresses are to be selectively installed in the DRAM cache, and should be further capable of determining when the memory addresses should be installed in and/or evicted from the DRAM cache. It may also be desirable for a DRAM cache management mechanism to minimize impact on access latency for the DRAM cache, and to be scalable with respect to the DRAM cache size and/or the system memory DRAM size.

Some approaches to DRAM cache management utilize a cache for storing tags corresponding to cached memory addresses. Under one such approach, a tag cache is stored in static random access memory (SRAM) on a compute die separate from the high-bandwidth memory. However, this approach may not be sufficiently scalable to the DRAM cache size, as larger DRAM cache sizes may require large tag caches that are not desired and/or are too large to store in SRAM. Another approach involves reducing the amount of SRAM used, and using a hit/miss predictor to determine whether a given memory address is stored within the DRAM cache. While this latter approach minimizes the usage of SRAM, any incorrect predictions will result in data being read from the system memory DRAM. Reads to the system memory DRAM incur additional access latency, which may negate any performance improvements resulting from using the DRAM cache. Still other approaches may require prohibitively large data structures stored in the system memory DRAM in order to track cached data.

Thus, it is desirable to provide scalable DRAM cache management to improve memory bandwidth while minimizing latency penalties and system memory DRAM consumption.

### SUMMARY OF THE DISCLOSURE

Aspects disclosed in the detailed description include providing scalable dynamic random access memory (DRAM) cache management using tag directory caches. In some aspects, a DRAM cache management circuit is provided to manage access to a DRAM cache located in a high-bandwidth memory. The DRAM cache management circuit comprises a tag directory cache and an associated tag directory cache directory for the tag directory cache. The tag directory cache is used by the DRAM cache management circuit to cache tags (e.g., tags generated based on cached memory addresses) that are stored in the DRAM cache of the high-bandwidth memory. The tag directory cache directory provides the DRAM cache management circuit with a list of tags stored within the tag directory cache. The tags stored in the tag directory cache and the tag directory cache directory enable the DRAM cache management circuit to determine whether a tag corresponding to a requested memory address is cached in the DRAM cache of the high-bandwidth memory. Based on the tag directory cache and the tag directory cache directory, the DRAM cache management circuit may access the DRAM cache to determine whether a memory operation may be performed using the DRAM cache and/or using a system memory DRAM. Some aspects of the DRAM cache management circuit may further provide a load balancing circuit. In circumstances in which data is read from either the DRAM cache or the system memory DRAM, the DRAM cache management circuit may use the load balancing circuit to select an appropriate source from which to read data.

Further aspects of the DRAM cache management circuit may be configured to operate in a write-through mode or a write-back mode. In the latter aspect, the tag directory cache directory may further provide a dirty bit for each cache line stored in the tag directory cache. Some aspects may minimize latency penalties on memory read accesses by allowing dirty data in the DRAM cache in a write-back mode only if the tag directory cache directory is configured to track dirty bits. A memory read access that misses on the tag directory cache thus may be allowed to go to the system memory DRAM, because if the corresponding cache line is in the DRAM cache, it is consistent with the data in the system memory DRAM. In some aspects, the tag directory cache and the tag directory cache directory may be replenished based on a probabilistic determination by the DRAM cache management circuit.

In another aspect, a DRAM cache management circuit is provided. The DRAM cache management circuit is communicatively coupled to a DRAM cache that is part of a high-bandwidth memory, and is further communicatively coupled to a system memory DRAM. The DRAM cache management circuit comprises a tag directory cache configured to cache a plurality of tags of a tag directory of the DRAM cache. The DRAM cache management circuit also comprises a tag directory cache directory that is configured to store a plurality of tags of the tag directory cache. The DRAM cache management circuit is configured to receive a memory read request comprising a read address, and determine whether the read address is found in the tag directory cache directory. The DRAM cache management circuit is further configured to, responsive to determining that the read address is not found in the tag directory cache directory, read data at the read address in the system memory DRAM. The DRAM cache management circuit is also configured to, responsive to determining that the read address is found in the tag directory cache directory, determine, based on the tag directory cache, whether the read address is found in the DRAM cache. The DRAM cache management circuit is additionally configured to, responsive to determining that the read address is not found in the DRAM cache, read data at the read address in the system memory DRAM. The DRAM cache management circuit is further configured to, responsive to determining that the read address is found in the DRAM cache, read data for the read address from the DRAM cache.

In another aspect, a method for providing scalable DRAM cache management is provided. The method comprises receiving, by a DRAM cache management circuit, a memory read request comprising a read address. The method further comprises determining whether the read address is found in a tag directory cache directory of a tag directory cache of the DRAM cache management circuit. The method also comprises, responsive to determining that the read address is not found in the tag directory cache directory, read data at the read address in a system memory DRAM. The method additionally comprises, responsive to determining that the read address is found in the tag directory cache directory, determining, based on the tag directory cache, whether the read address is found in a DRAM cache that is part of a high-bandwidth memory. The method further comprises, responsive to determining that the read address is not found in the DRAM cache, reading data at the read address in the system memory DRAM. The method also comprises, responsive to determining that the read address is found in the DRAM cache, reading data for the read address from the DRAM cache.

In another aspect, a DRAM cache management circuit is provided. The DRAM cache management circuit comprises means for receiving a memory read request comprising a read address. The DRAM cache management circuit further comprises means for determining whether the read address is found in a tag directory cache directory of a tag directory cache of the DRAM cache management circuit. The DRAM cache management circuit also comprises means for reading data at the read address in a system memory DRAM, responsive to determining that the read address is not found in the tag directory cache directory. The DRAM cache management circuit additionally comprises means for determining, based on the tag directory cache, whether the read address is found in a DRAM cache that is part of a high-bandwidth memory, responsive to determining that the read address is found in the tag directory cache directory. The DRAM cache management circuit further comprises means for reading data at the read address in the system memory DRAM, responsive to determining that the read address is not found in the DRAM cache. The DRAM cache management circuit also comprises means for reading data for the read address from the DRAM cache, responsive to determining that the read address is found in the DRAM cache.

### BRIEF DESCRIPTION OF THE FIGURES

FIG. 1 is a block diagram of an exemplary processor-based system including a high-bandwidth memory providing a dynamic random access memory (DRAM) cache, and a DRAM cache management circuit for providing scalable DRAM cache management using a tag directory cache and a tag directory cache directory;

FIGS. 2A-2B are block diagrams illustrating a comparison of exemplary implementations of the DRAM cache that may be managed by the DRAM cache management circuit of FIG. 1, where the implementations provide different DRAM cache line sizes;

FIGS. 3A and 3B are flowcharts illustrating exemplary operations of the DRAM cache management circuit of FIG. 1 for performing a read operation using the tag directory cache and the tag directory cache directory of FIG. 1;

FIGS. 4A-4E are flowcharts illustrating exemplary operations of the DRAM cache management circuit of FIG. 1 for performing a write operation resulting from an eviction of data from a system cache (e.g., “clean” (i.e., unmodified) or “dirty” (i.e., modified) evicted data, evicted in a write-back mode or a write-through mode);

FIGS. 5A-5D are flowcharts illustrating exemplary operations of the DRAM cache management circuit of FIG. 1 for performing a tag directory cache installation operation; and

FIG. 6 is a block diagram of an exemplary processor-based system that can include the DRAM cache management circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

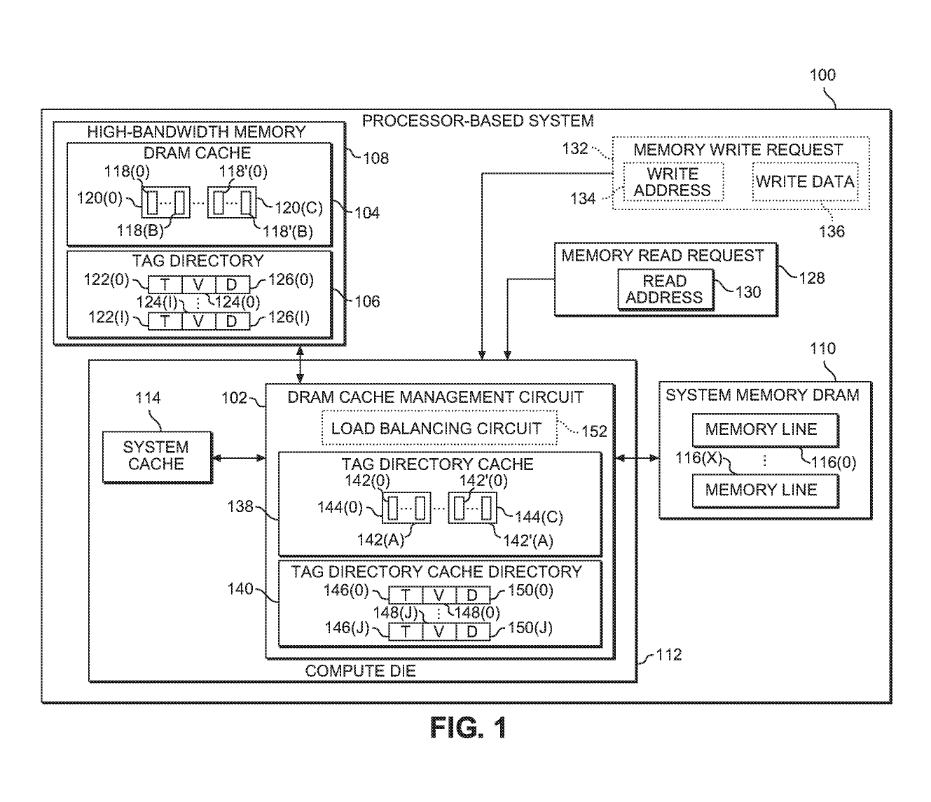

Aspects disclosed in the detailed description include providing scalable dynamic random access memory (DRAM) cache management using tag directory caches. As described herein, a DRAM cache management scheme is “scalable” in the sense that the size of the resources utilized by the DRAM cache management scheme is relatively independent of the capacity of the DRAM cache being managed. Accordingly, in this regard, FIG. 1 is a block diagram of an exemplary processor-based system 100 that provides a DRAM cache management circuit 102 for managing a DRAM cache 104 and an associated tag directory 106 for the DRAM cache 104, both of which are part of a high-bandwidth memory 108. The processor-based system 100 includes a system memory DRAM 110, which, in some aspects, may comprise one or more dual in-line memory modules (DIMMs). The processor-based system 100 further provides a compute die 112, on which a system cache 114 (e.g., a Level 3 (L3) cache, as a non-limiting example) is located. In some aspects, the size of the tag directory 106 is proportional to the size of the DRAM cache 104, and, thus, may be small enough to fit in the high-bandwidth memory 108 along with the DRAM cache 104. Consequently, the system memory DRAM 110 does not have to be accessed to retrieve tag directory 106 information for the DRAM cache 104.

The processor-based system 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that some aspects of the processor-based system 100 may include elements in addition to those illustrated in FIG. 1.

To improve memory bandwidth, the DRAM cache 104 within the high-bandwidth memory 108 of the processor-based system 100 may be used to cache memory addresses (not shown) and data (not shown) that were previously read from memory lines 116(0)-116(X) within the system memory DRAM 110, and/or evicted from the system cache 114. As non-limiting examples, some aspects may provide that data may be cached in the DRAM cache 104 only upon reading the data from the system memory DRAM 110, while in some aspects data may be cached in the DRAM cache 104 only when evicted from the system cache 114. According to some aspects, data may be cached in the DRAM cache 104 upon reading data from the system memory DRAM 110 for reads triggered by processor loads and dirty evictions from the system cache 114.

The DRAM cache 104 provides DRAM cache lines 118(0)-118(B), 118′(0)-118′(B) organized into ways 120(0)-120(C) to store the previously read memory addresses and data. For each of the DRAM cache lines 118(0)-118(B), 118′(0)-118′(B) within the DRAM cache 104, the tag directory 106 for the DRAM cache 104 stores a tag 122(0)-122(I) generated from a memory address of the corresponding DRAM cache line 118(0)-118(B), 118′(0)-118′(B). As an example, in an exemplary processor-based system 100 in which the system memory DRAM 110 is four (4) terabytes in size, memory addresses for the DRAM cache lines 118(0)-118(B), 118′(0)-118′(B) may each include 42 bits. The 12 most significant bits of the memory addresses (i.e., bits 41 to 30) may be used as tags 122(0)-122(I) (“T”) for the memory addresses in the tag directory 106. The tag directory 106 also stores valid bits 124(0)-124(I) (“V”) indicating whether the corresponding tags 122(0)-122(I) are valid, and dirty bits 126(0)-126(I) (“D”) indicating whether the DRAM cache lines 118(0)-118(B), 118′(0)-118′(B) corresponding to the tags 122(0)-122(1) have been modified. In some aspects, dirty data may be allowed in the DRAM cache 104 only if the DRAM cache management circuit 102 is configured to track the dirty data (e.g., by supporting a write-back mode).

The DRAM cache 104 within the high-bandwidth memory 108 may be accessed independently of and in parallel with the system memory DRAM 110. As a result, memory bandwidth may be effectively increased by reading from both the DRAM cache 104 and the system memory DRAM 110 at the same time. In some aspects, the DRAM cache 104 may implement a random replacement policy to determine candidates for eviction within the DRAM cache 104, while some aspects may implement other replacement policies optimized for specific implementations of the DRAM cache 104.

Accessing the tag directory 106 of the DRAM cache 104 for each memory operation may incur latency penalties that could offset the performance benefits of using the DRAM cache 104. Thus, it is desirable to provide a scalable mechanism for managing access to the DRAM cache 104 to improve memory bandwidth while minimizing latency penalties. In this regard, the DRAM cache management circuit 102 is provided to manage access to the DRAM cache 104. The DRAM cache management circuit 102 is located on the compute die 112, and is communicatively coupled to the high-bandwidth memory 108 and the system memory DRAM 110. The DRAM cache management circuit 102 may also be read from and written to by the system cache 114, and/or by other master devices (not shown) in the processor-based system 100 (e.g., a central processing unit (CPU), input/output (I/O) interfaces, and/or a graphics processing unit (GPU), as non-limiting examples). As discussed in greater detail below, the DRAM cache management circuit 102 may perform a memory read operation in response to receiving a memory read request 128 comprising a read address 130 specifying a memory address from which to retrieve data. Some aspects may provide that the memory read request 128 is received in response to a miss on the system cache 114. In some aspects, the DRAM cache management circuit 102 may further perform a memory write operation in response to receiving a memory write request 132 comprising a write address 134 to which write data 136 is to be written.

To reduce access latency that may result from accesses to the tag directory 106, the DRAM cache management circuit 102 provides a tag directory cache 138 and a tag directory cache directory 140 for the tag directory cache 138. To cache the tags 122(0)-122(I) from the tag directory 106 corresponding to frequently accessed DRAM cache lines 118(0)-118(B), 118′(0)-118′(B) within the DRAM cache 104, the tag directory cache 138 provides tag directory cache lines 142(0)-142(A), 142′(0)-142′(A) organized into ways 144(0)-144(C). Each of the tag directory cache lines 142(0)-142(A), 142′(0)-142′(A) within the tag directory cache 138 may store a block of memory from the tag directory 106 containing the tags 122(0)-122(I) for multiple DRAM cache lines 118(0)-118(B), 118′(0)-118′(B) of the DRAM cache 104. As a non-limiting example, in some aspects, the tags 122(0)-122(I) stored in the tag directory 106 for the DRAM cache 104 may be 16 bits each, while the tag directory cache lines 142(0)-142(A), 142′(0)-142′(A) within the tag directory cache 138 may be 64 bytes each. Thus, each of the tag directory cache lines 142(0)-142(A), 142′(0)-142′(A) within the tag directory cache 138 may store 32 tags 122(0)-122(31) from the tag directory 106.

For each tag directory cache line 142(0)-142(A), 142′(0)-142′(A) within the tag directory cache 138, the tag directory cache directory 140 for the tag directory cache 138 stores a tag 146(0)-146(J) (“T”) generated from the memory address of the corresponding DRAM cache line 118(0)-118(B), 118′(0)-118′(B) of the DRAM cache 104. For example, in an exemplary processor-based system 100 in which memory addresses include 42 bits, bits 29 to 17 (which may represent a portion of the memory address used to determine a set of the DRAM cache 104 in which data for the memory address will be stored) may be used as a tag 146(0)-146(J) for the memory address in the tag directory cache directory 140. The tag directory cache directory 140 for the tag directory cache 138 also stores valid bits 148(0)-148(J) (“V”) indicating whether the corresponding tags 146(0)-146(J) are valid, and dirty bits 150(0)-150(J) (“D”) indicating whether the tag directory cache lines 142(0)-142(A), 142′(0)-142′(A) corresponding to the tags 146(0)-146(J) have been modified.

In some aspects, the DRAM cache management circuit 102 further provides a load balancing circuit 152 to improve memory bandwidth and reduce memory access contention. In circumstances in which a requested memory address can be read from either the system memory DRAM 110 or the DRAM cache 104, the load balancing circuit 152 determines the most appropriate source from which to read the memory address, based on load balancing criteria such as bandwidth and latency, as non-limiting examples. In this manner, the load balancing circuit 152 may distribute memory accesses between the system memory DRAM 110 and the DRAM cache 104 to optimize the use of system resources.

In some aspects, the DRAM cache management circuit 102 may be implemented as a “write-through” cache management system. In a write-through implementation, dirty (i.e., modified) data evicted from the system cache 114 is written by the DRAM cache management circuit 102 to both the DRAM cache 104 of the high-bandwidth memory 108 and the system memory DRAM 110. As a result, the data within the DRAM cache 104 and the data within the system memory DRAM 110 are always synchronized. Because both the DRAM cache 104 and the system memory DRAM 110 in a write-through implementation are guaranteed to contain correct data, the load balancing circuit 152 of the DRAM cache management circuit 102 may freely load-balance memory read operations between the DRAM cache 104 and the system memory DRAM 110. However, the write-through implementation of the DRAM cache management circuit 102 may not result in decreased write bandwidth to the system memory DRAM 110, because each write to the DRAM cache 104 will correspond to a write to the system memory DRAM 110.

Some aspects of the DRAM cache management circuit 102 may be implemented as a “write-back” cache management system, in which the tag directory cache lines 142(0)-142(A), 142′(0)-142′(A) of the tag directory cache 138 caches the dirty bits 126(0)-126(I) along with the tags 122(0)-122(I) from the tag directory 106 of the DRAM cache 104. The dirty bits 126(0)-126(I) indicate whether data stored in the DRAM cache 104 corresponding to the tags 122(0)-122(I) cached within the tag directory cache 138 is dirty (i.e., whether the data was written to the DRAM cache 104 but not to the system memory DRAM 110). If the data is not dirty, the data may be read from either the DRAM cache 104 or the system memory DRAM 110, as determined by the load balancing circuit 152 of the DRAM cache management circuit 102. However, if the dirty bits 126(0)-126(I) cached in the tag directory 106 indicates that the data stored in the DRAM cache 104 is dirty, load balancing is not possible, as the DRAM cache 104 is the only source for the modified data. Accordingly, the DRAM cache management circuit 102 reads the dirty data from the DRAM cache 104. The write-back implementation of the DRAM cache management circuit 102 may reduce memory write bandwidth to the system memory DRAM 110, but the DRAM cache management circuit 102 must eventually write back dirty data evicted from the DRAM cache 104 to the system memory DRAM 110. In some aspects of the write-back implementation of the DRAM cache management circuit 102, when one of the tag directory cache lines 142(0)-142(A), 142′(0)-142′(A) is evicted from the tag directory cache 138, the DRAM cache management circuit 102 is configured to copy all dirty data in the DRAM cache 104 corresponding to the evicted tag directory cache lines 142(0)-142(A), 142′(0)-142′(A) to the system memory DRAM 110.

Some aspects of the DRAM cache management circuit 102 may further improve memory bandwidth by performing some operations (e.g., operations involving memory accesses to the system memory DRAM 110 and/or the DRAM cache 104, and/or updates to the tag directory cache 138 and the tag directory cache directory 140, as non-limiting examples) according to corresponding probabilistic determinations made by the DRAM cache management circuit 102. Each probabilistic determination may be used to tune the frequency of the corresponding operation, and may be stateless (i.e., not related to the outcome of previous probabilistic determinations). For example, according to some aspects of the DRAM cache management circuit 102, data evicted by the system cache 114 may be written to the DRAM cache 104 based on a probabilistic determination, such that only a percentage of randomly-selected data evicted by the system cache 114 is written to the DRAM cache 104. Similarly, some aspects of the DRAM cache management circuit 102 may be configured to replenish the tag directory cache 138 based on a probabilistic determination. Thus, it is to be understood that each operation described herein as occurring “probabilistically” may or may not be performed in a given instance, and further that the occurrence or lack thereof of a given probabilistic operation may further trigger additional operations by the DRAM cache management circuit 102.

The amount of memory that can be tracked by the tag directory cache 138 may be increased in some aspects by making the cache line size of the DRAM cache lines 118(0)-118(B), 118′(0)-118′(B) of the DRAM cache 104 a multiple of the system cache line size. In such aspects, referred to as “sectored DRAM caches with segmented cache lines,” multiple memory lines 116(0)-116(X) of the system memory DRAM 110 may be stored in corresponding data segments (not shown) of a single DRAM cache line 118(0)-118(B), 118′(0)-118′(B) of the DRAM cache 104. Each data segment within a DRAM cache line 118(0)-118(B), 118′(0)-118′(B) of the DRAM cache 104 may be managed, accessed, and updated independently, with only dirty data segments needing to be written back to the system memory DRAM 110. However, cache line allocation, eviction, and replacement from the DRAM cache 104 must be done at the granularity of the cache line size of the DRAM cache 104.

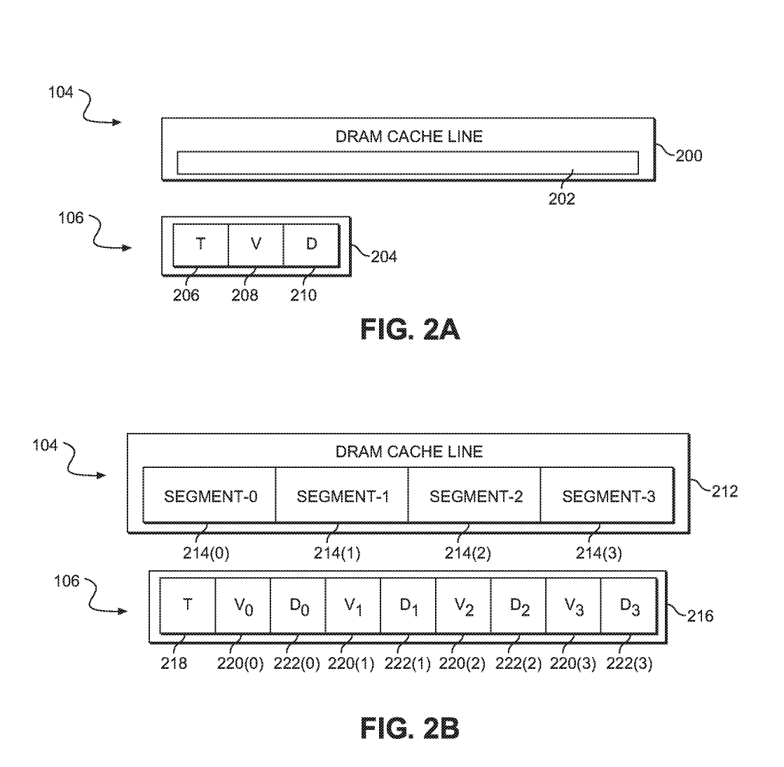

To illustrate a comparison of exemplary implementations of the DRAM cache 104 that may be managed by the DRAM cache management circuit 102 of FIG. 1, FIGS. 2A-2B are provided. FIG. 2A illustrates the DRAM cache 104 providing a cache line size equal to the system cache line size, while FIG. 2B illustrates the DRAM cache 104 providing a cache line size equal to four (4) times the system cache line size. For the sake of clarity, elements of FIG. 1 are referenced in describing FIGS. 2A and 2B.

In FIG. 2A, a DRAM cache line 200 is shown. The DRAM cache line 200, in some aspects, may correspond to one of the DRAM cache lines 118(0)-118(B), 118′(0)-118′(B) of FIG. 1. In the example of FIG. 2A, the DRAM cache line 200 is the same size as the system cache line size. Thus, the DRAM cache line 200 can store a single cached memory line 202 (corresponding to one of the memory lines 116(0)-116(X) of FIG. 1) from the system memory DRAM 110. To identify and track the state of the cached memory line 202, a tag directory entry 204 of the tag directory 106 for the DRAM cache 104 includes an address tag 206 (“T”), a valid bit 208 (“V”), and a dirty bit 210 (“D”). In contrast, FIG. 2B illustrates a DRAM cache line 212 that is four (4) times the system cache line size. Accordingly, the DRAM cache line 212, corresponding to one of the DRAM cache lines 118(0)-118(B), 118′(0)-118′(B) of FIG. 1, comprises four (4) data segments 214(0)-214(3). Each of the data segments 214(0)-214(3) is able to store a cached memory line 116(0)-116(X) (not shown) from the system memory DRAM 110. A tag directory entry 216 includes an address tag 218 (“T”) for the DRAM cache line 212, and further includes four (4) valid bits 220(0)-220(3) (“V₀-V₃”) and four (4) dirty bits 222(0)-222(3) (“D₀-D₃”) corresponding to the data segments 214(0)-214(3). The valid bits 220(0)-220(3) and the dirty bits 222(0)-222(3) allow each of the data segments 214(0)-214(3) to be managed independently of the other data segments 214(0)-214(3).

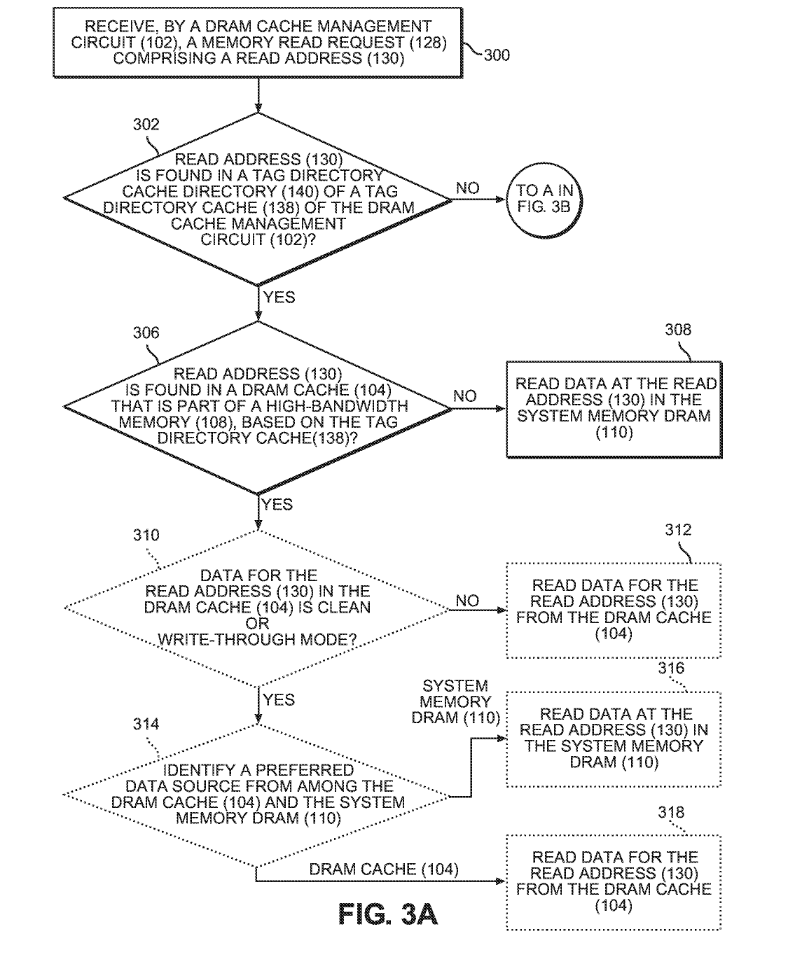

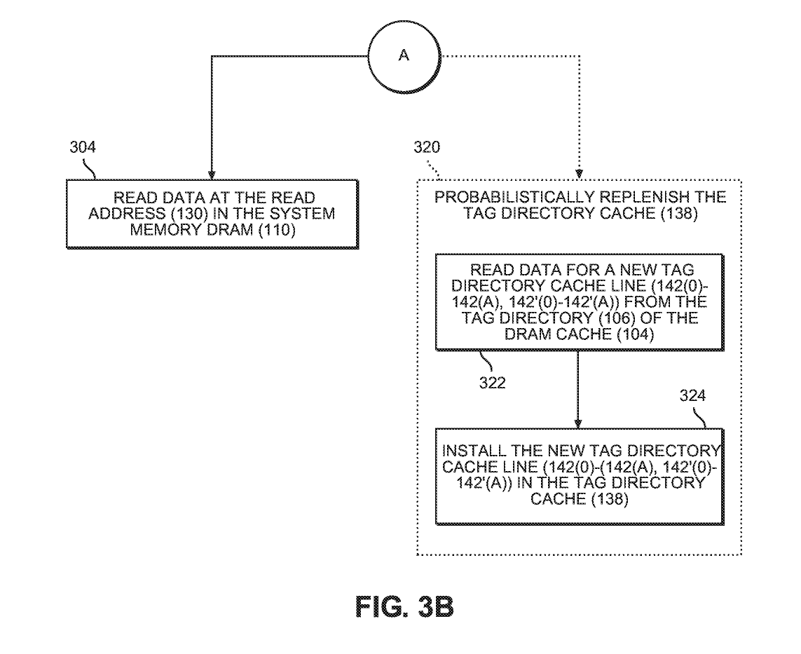

FIGS. 3A-3B are flowcharts illustrating exemplary operations of the DRAM cache management circuit 102 of FIG. 1 for performing a read operation using the tag directory cache 138 and the DRAM cache 104 of FIG. 1. Elements of FIG. 1 are referenced in describing FIGS. 3A-3B for the sake of clarity. In FIG. 3A, operations begin with the DRAM cache management circuit 102 receiving a memory read request 128 comprising a read address 130 (block 300). In this regard, the DRAM cache management circuit 102 may be referred to herein as a “means for receiving a memory read request comprising a read address.” The DRAM cache management circuit 102 determines whether the read address 130 is found in the tag directory cache directory 140 of the tag directory cache 138 of the DRAM cache 104 (block 302). Accordingly, the DRAM cache management circuit 102 may be referred to herein as a “means for determining whether the read address is found in a tag directory cache directory of a tag directory cache of the DRAM cache management circuit.” In some aspects, determining whether the read address 130 is found in the tag directory cache directory 140 may include determining whether one of the tags 146(0)-146(J) corresponds to the read address 130. As a non-limiting example, for a 42-bit read address 130, a corresponding tag 146(0)-146(J) within the tag directory cache directory 140 for the tag directory cache 138 may comprise bits 29 to 17 of the read address 130, which may represent a set of the DRAM cache 104 in which data for the read address 130 would be stored.

If the DRAM cache management circuit 102 determines at decision block 302 that the read address 130 is not found in the tag directory cache directory 140, processing resumes at block 304 of FIG. 3B. However, if the read address 130 is found in the tag directory cache directory 140, the DRAM cache management circuit 102 next determines whether the read address 130 is found in the DRAM cache 104 that is part of the high-bandwidth memory 108, based on the tag directory cache 138 (block 306). The DRAM cache management circuit 102 may thus be referred to herein as a “means for determining, based on the tag directory cache, whether the read address is found in a DRAM cache that is part of a high-bandwidth memory, responsive to determining that the read address is found in the tag directory cache directory.” As described above, the tag directory cache 138 caches a subset of the tags 122(0)-122(I) from the tag directory 106 for the DRAM cache 104. For a 42-bit read address 130, each of the tags 122(0)-122(I) within the tag directory 106 (and, thus, cached in the tag directory cache 138) may comprise, as a non-limiting example, the 12 most significant bits of the read address 130 (i.e., bits 41 to 30). Because the tag directory cache directory 140 for the tag directory cache 138 may use a different set of bits within the read address 130 for the tags 146(0)-146(J), it is possible for a given read address 130 to result in a hit in the tag directory cache directory 140 for the tag directory cache 138 at block 302, and yet not actually be cached in the DRAM cache 104.

Accordingly, if the DRAM cache management circuit 102 determines at decision block 306 that the read address 130 is not found in the DRAM cache 104, the DRAM cache management circuit 102 reads data at the read address 130 in the system memory DRAM 110 (block 308). In this regard, the DRAM cache management circuit 102 may be referred to herein as a “means for reading data at the read address in the system memory DRAM, responsive to determining that the read address is not found in the DRAM cache.” If the read address 130 is found in the DRAM cache 104, the DRAM cache management circuit 102 may determine whether the data for the read address 130 in the DRAM cache 104 is clean (or whether the DRAM cache management circuit 102 is operating in a write-through mode) (block 310). If not, the requested data can be read safely only from the DRAM cache 104, and thus the DRAM cache management circuit 102 reads data for the read address 130 from the DRAM cache 104 (block 312). The DRAM cache management circuit 102 may thus be referred to herein as a “means for reading data for the read address from the DRAM cache, responsive to determining that the read address is found in the DRAM cache.”

On the other hand, if the DRAM cache management circuit 102 determines at decision block 310 that the data for the read address 130 in the DRAM cache 104 is clean (or that the DRAM cache management circuit 102 is operating in a write-through mode), then both the DRAM cache 104 and the system memory DRAM 110 contain the same copy of the requested data. The DRAM cache management circuit 102 thus identifies (e.g., using the load balancing circuit 152) a preferred data source from among the DRAM cache 104 and the system memory DRAM 110 (block 314). If the system memory DRAM 110 is identified as the preferred data source, the DRAM cache management circuit 102 reads data at the read address 130 in the system memory DRAM 110 (block 316). Otherwise, the DRAM cache management circuit 102 reads data for the read address 130 from the DRAM cache 104 (block 318)

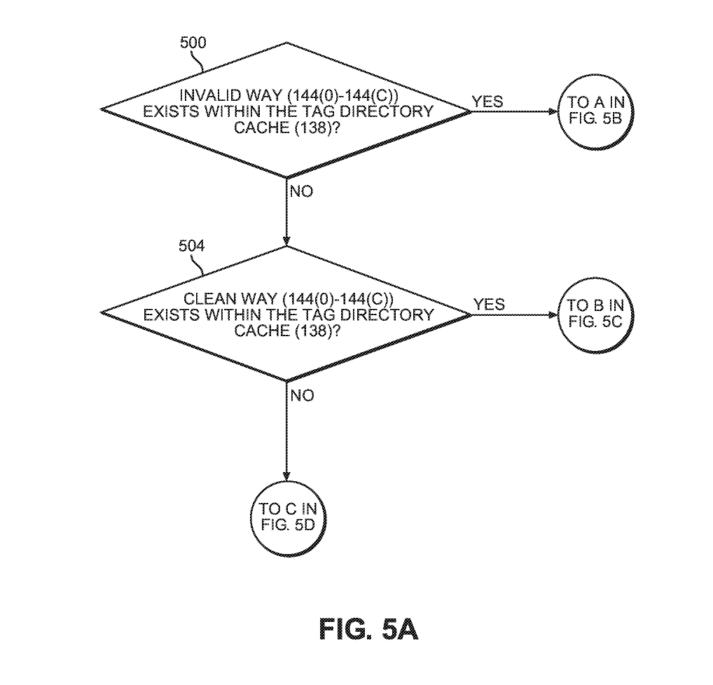

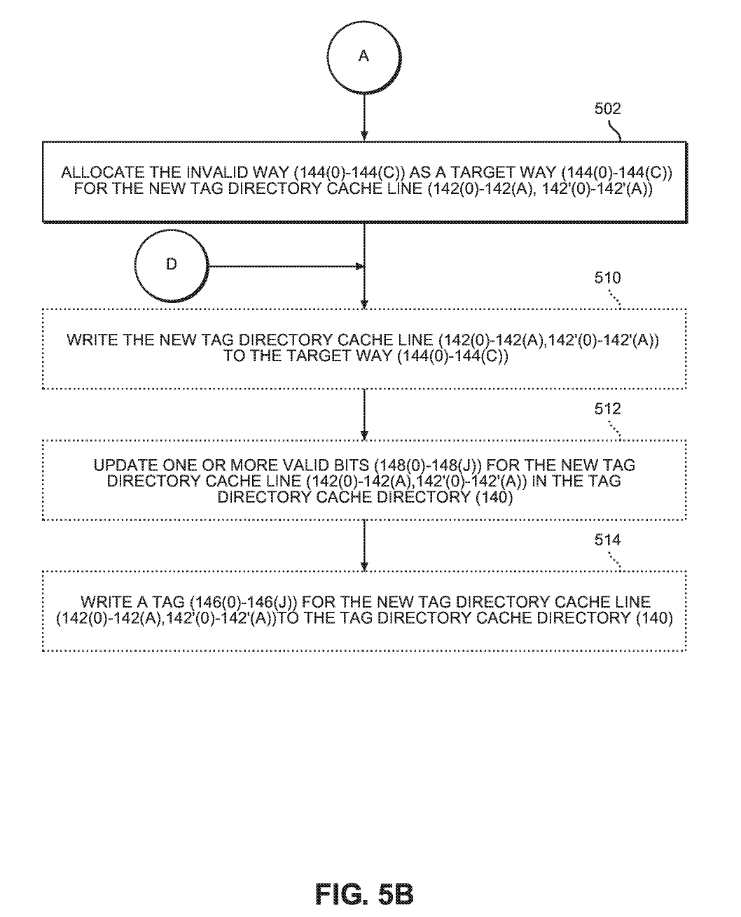

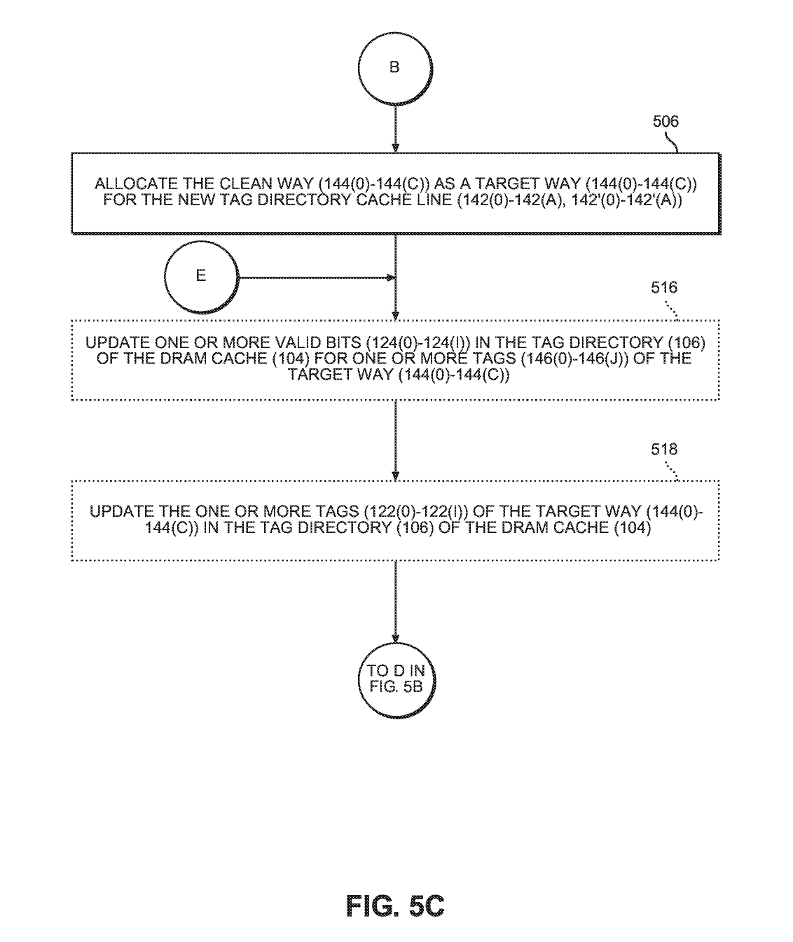

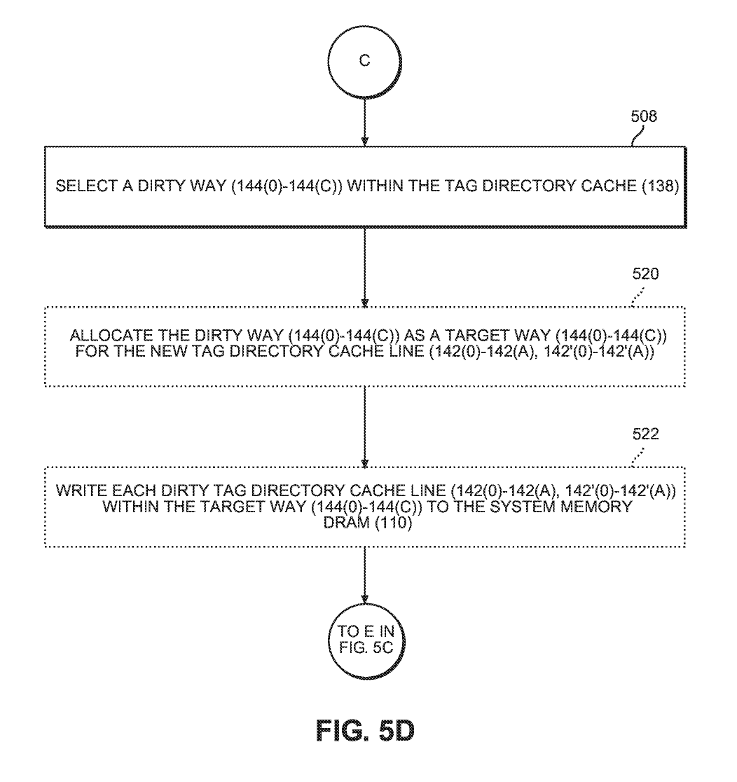

Referring now to FIG. 3B, if the DRAM cache management circuit 102 determines at decision block 302 of FIG. 3A that the read address 130 is not found in the tag directory cache directory 140, the DRAM cache management circuit 102 reads data at the read address 130 in the system memory DRAM 110 (block 304). Accordingly, the DRAM cache management circuit 102 may be referred to herein as a “means for reading data at the read address in a system memory DRAM, responsive to determining that the read address is not found in the tag directory cache directory.” In some aspects, the DRAM cache management circuit 102 may also probabilistically replenish the tag directory cache 138 in parallel with reading the data at the read address 130 in the system memory DRAM 110 (block 320). According to some aspects, operations for probabilistically replenishing the tag directory cache 138 may include first reading data for a new tag directory cache line 142(0)-142(A), 142′(0)-142′(A) from the tag directory 106 of the DRAM cache 104 (block 322). The new tag directory cache line 142(0)-142(A), 142′(0)-142′(A) is then installed in the tag directory cache 138 (block 324). Additional operations for installing tag directory cache lines 142(0)-142(A), 142′(0)-142′(A) in the tag directory cache 138 are discussed in greater detail below with respect to FIGS. 5A-5D.

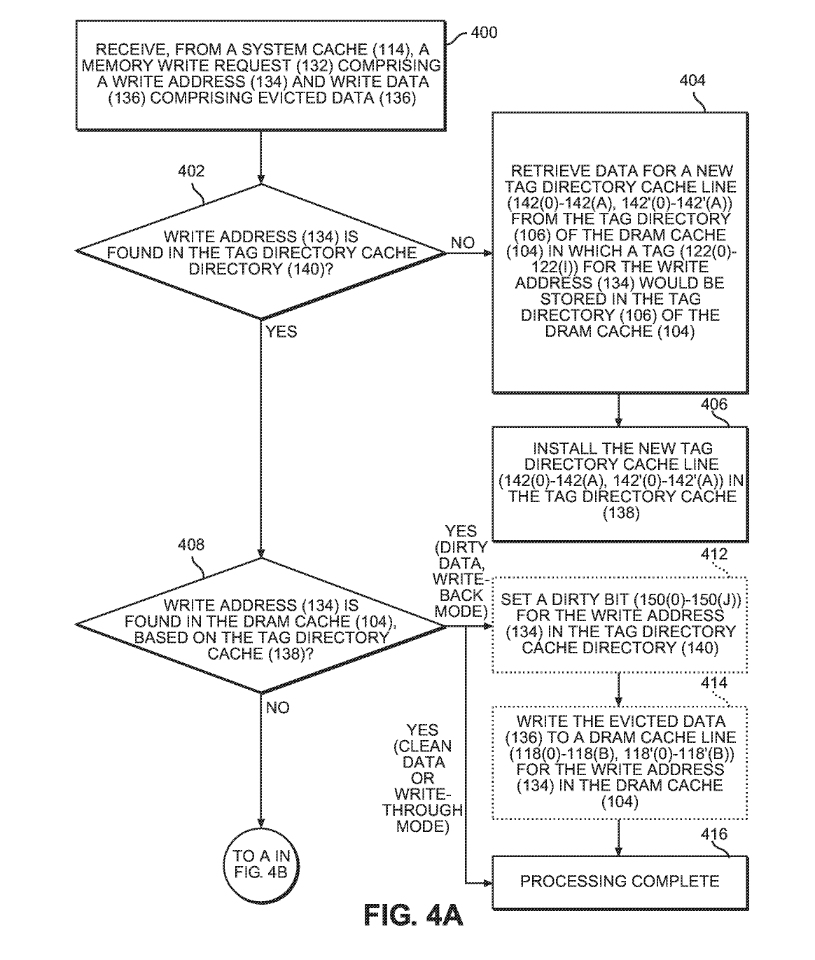

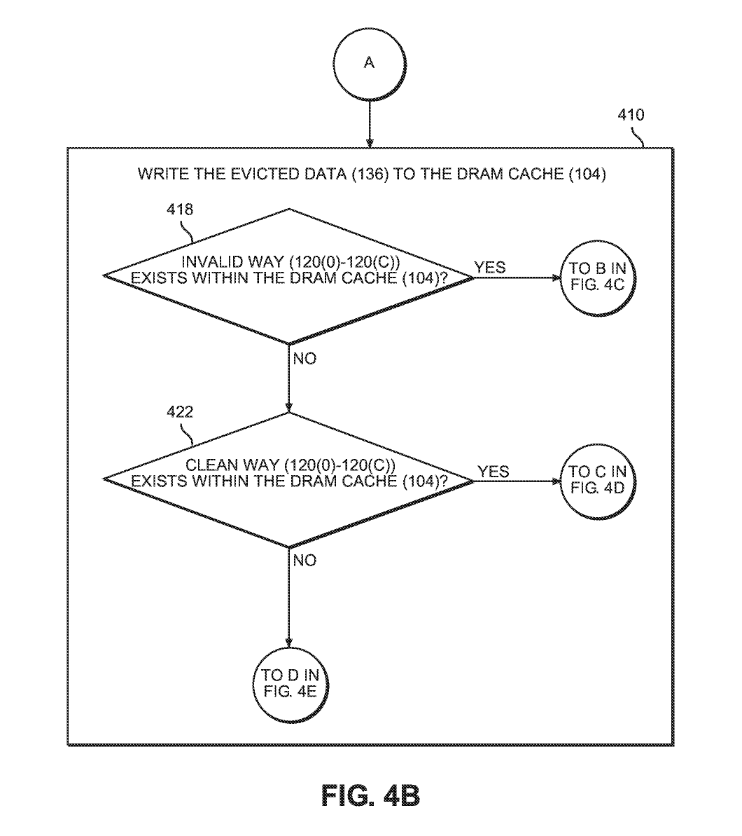

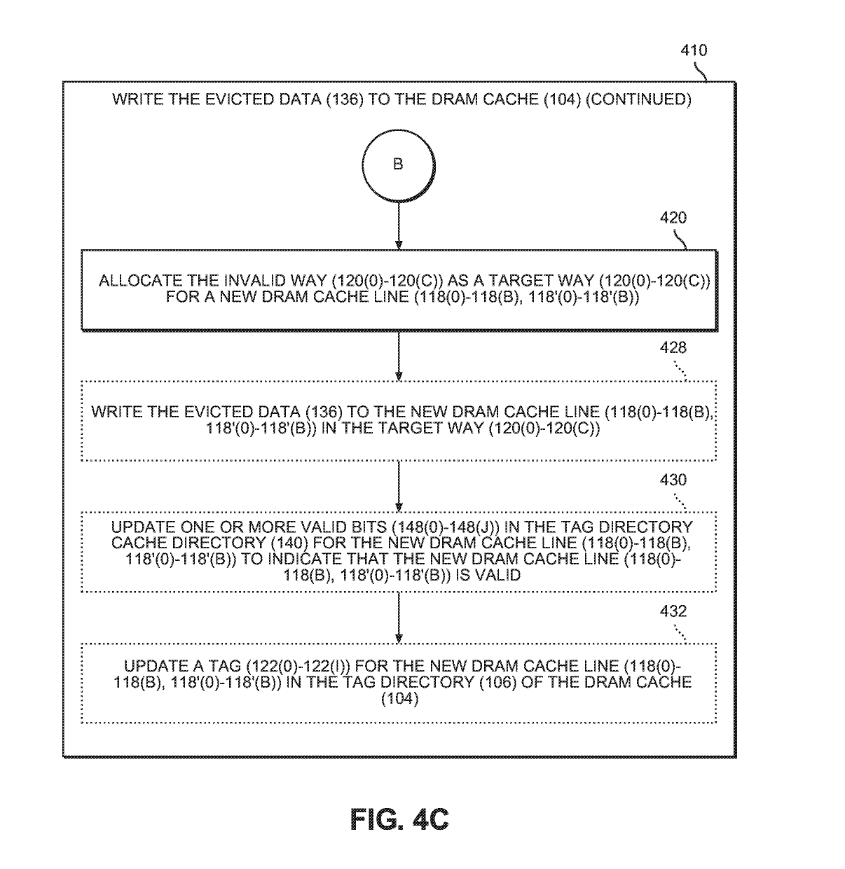

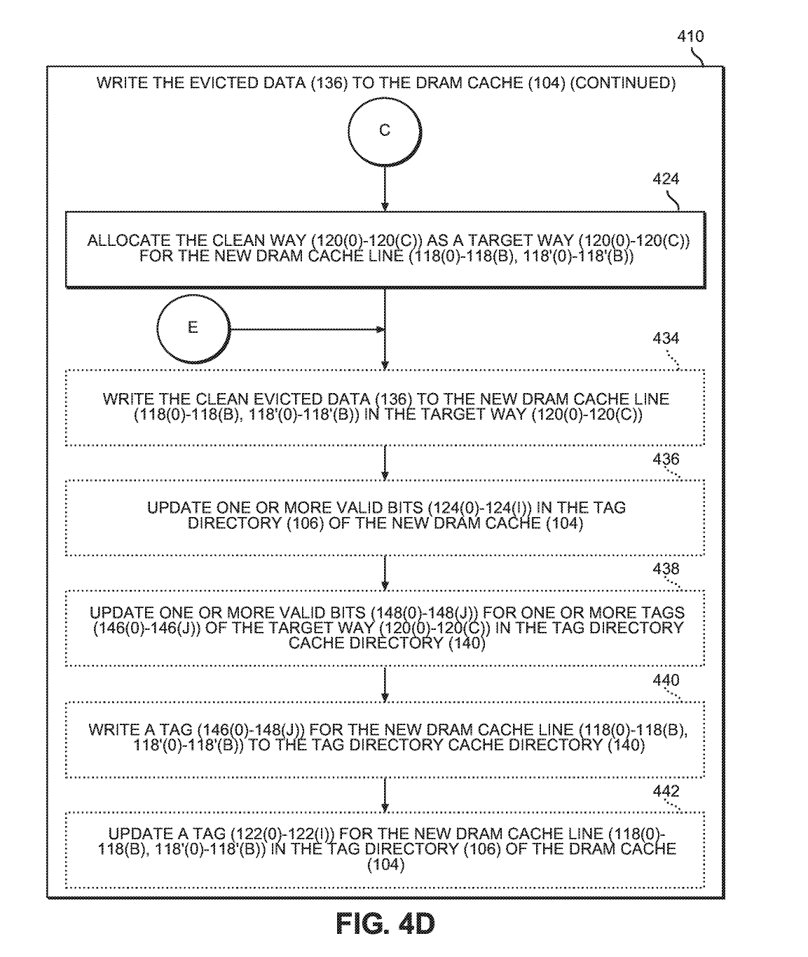

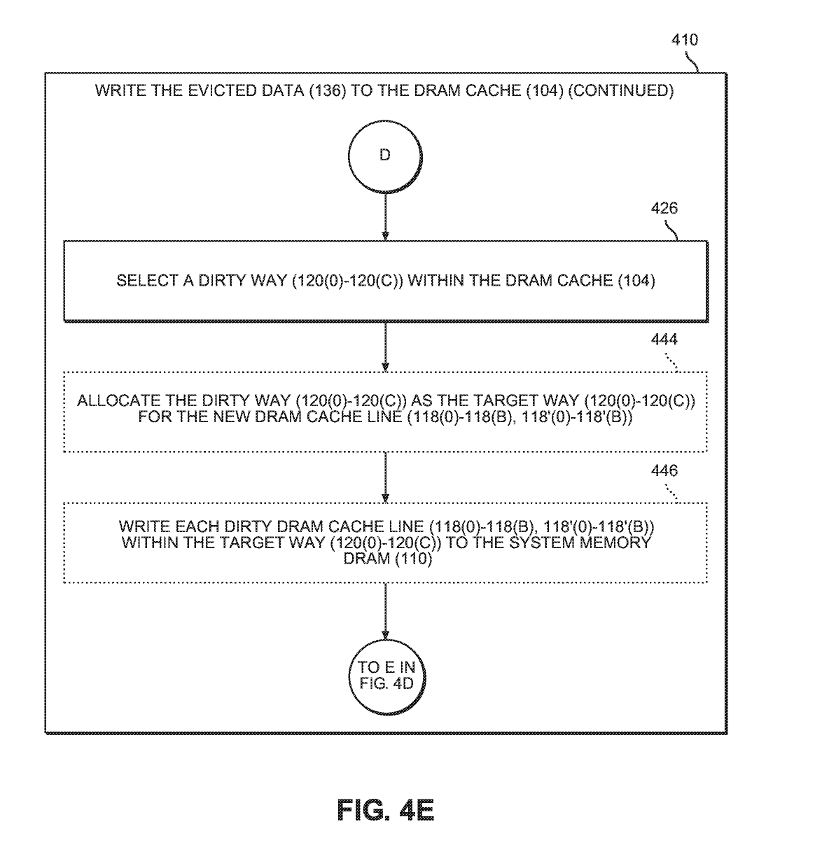

To illustrate exemplary operations of the DRAM cache management circuit 102 of FIG. 1 for performing a write operation resulting from an eviction of data (clean or dirty) from the system cache 114 in a write-through or write-back mode, FIGS. 4A-4E are provided. For the sake of clarity, elements of FIG. 1 are referenced in describing FIGS. 4A-4E. Additionally, operations that pertain only to writing clean evicted data or dirty evicted data and/or operations that are relevant only to a write-through mode or a write-back mode in some aspects are designated as such in describing FIGS. 4A-4E.

Operations in FIG. 4A begin with the DRAM cache management circuit 102 receiving, from the system cache 114 (e.g., an L3 cache, as a non-limiting example), the memory write request 132 comprising the write address 134 and the write data 136 (referred to herein as “evicted data 136”) (block 400). The evicted data 136 may comprise clean evicted data or dirty evicted data, and thus may be further referred to herein as “clean evicted data 136” or “dirty evicted data 136,” as appropriate. As noted below, handling of clean evicted data 136 and dirty evicted data 136 may vary according to whether the DRAM cache management circuit 102 is configured to operate in a write-through mode or a write-back mode. Any such differences in operation are noted below in describing FIGS. 4A-4E.

The DRAM cache management circuit 102 next determines whether the write address 134 is found in the tag directory cache directory 140 (block 402). Some aspects may provide that determining whether the write address 134 is found in the tag directory cache directory 140 may include determining whether one of the tags 146(0)-146(J) corresponds to the write address 134. If the write address 134 is not found in the tag directory cache directory 140, the DRAM cache management circuit 102 retrieves data for a new tag directory cache line 142(0)-142(A), 142′(0)-142′(A) from the tag directory 106 of the DRAM cache 104 in which a tag 122(0)-122(I) for the write address 134 would be stored in the tag directory 106 of the DRAM cache 104 (block 404). The DRAM cache management circuit 102 then installs the new tag directory cache line 142(0)-142(A), 142′(0)-142′(A) in the tag directory cache 138 (block 406). Exemplary operations of block 406 for installing the new tag directory cache line 142(0)-142(A), 142′(0)-142′(A) in the tag directory cache 138 according to some aspects are discussed in greater detail with respect to FIGS. 5A-5D.

If the DRAM cache management circuit 102 determines at decision block 402 that the write address 134 is found in the tag directory cache directory 140, the DRAM cache management circuit 102 further determines whether the write address 134 is found in the DRAM cache 104, based on the tag directory cache 138 (block 408). As noted above, this operation is necessary because the tag directory cache directory 140 for the tag directory cache 138 may use a different set of bits within the write address 134 for the tags 146(0)-146(J). As a result, it is possible for the write address 134 to result in a hit in the tag directory cache directory 140 for the tag directory cache 138 at block 402, and yet not actually be cached in the DRAM cache 104. If the write address 134 is not found in the DRAM cache 104, processing resumes at block 410 of FIG. 4B. However, if the DRAM cache management circuit 102 determines at decision block 408 that the write address 134 is found in the DRAM cache 104, the DRAM cache management circuit 102 performs different operations depending on whether the evicted data 136 is clean or dirty, and whether the DRAM cache management circuit 102 is configured to operate in a write-back mode or a write-through mode. When writing the dirty evicted data 136 in a write-back mode, the DRAM cache management circuit 102 sets a dirty bit 150(0)-150(J) for the write address 134 in the tag directory cache directory 140 (block 412). The DRAM cache management circuit 102 then writes the evicted data 136 to a DRAM cache line 118(0)-118(B), 118′(0)-118′(B) for the write address 134 in the DRAM cache 104 (block 414). Processing is then complete (block 416). In contrast, if the evicted data 136 is clean evicted data 136, or the DRAM cache management circuit 102 operates in a write-through mode, and if the write address 134 is found in the DRAM cache 104 at decision block 408, processing is complete (block 416).

Referring now to FIG. 4B, if the DRAM cache management circuit 102 determines at decision block 408 of FIG. 4A that the write address 134 is not found in the DRAM cache 104, the DRAM cache management circuit 102 writes the evicted data 136 to the DRAM cache 104 (block 410). In some aspects, exemplary operations of block 410 for writing the evicted data 136 to the DRAM cache 104 may include first determining whether an invalid way 120(0)-120(C) exists within the DRAM cache 104 (block 418). If so, processing resumes at block 420 of FIG. 4C. If the DRAM cache management circuit 102 determines at decision block 418 that no invalid way 120(0)-120(C) exists within the DRAM cache 104, the DRAM cache management circuit 102 next determines whether a clean way 120(0)-120(C) exists within the DRAM cache 104 (block 422). If a clean way 120(0)-120(C) exists within the DRAM cache 104, processing resumes at block 424 of FIG. 4D. If not, processing resumes at block 426 of FIG. 4E.

In FIG. 4C, the operations of block 410 of FIG. 4B for writing the evicted data 136 to the DRAM cache 104 continue. The DRAM cache management circuit 102 first allocates the invalid way 120(0)-120(C) as a target way 120(0)-120(C) for a new DRAM cache line 118(0)-118(B), 118′(0)-118′(B) (block 420). The evicted data 136 is written to the new DRAM cache line 118(0)-118(B), 118′(0)-118′(B) in the target way 120(0)-120(C) (block 428). The DRAM cache management circuit 102 then updates one or more valid bits 148(0)-148(J) in the tag directory cache directory 140 for the new DRAM cache line 118(0)-118(B), 118′(0)-118′(B) to indicate that the new DRAM cache line 118(0)-118(B), 118′(0)-118′(B) is valid (block 430). Finally, the DRAM cache management circuit 102 updates a tag 122(0)-122(I) for the new DRAM cache line 118(0)-118(B), 118′(0)-118′(B) in the tag directory 106 of the DRAM cache 104 (block 432).

The operations of block 410 of FIG. 4B for writing the evicted data 136 to the DRAM cache 104 continue in FIG. 4D. In FIG. 4D, the DRAM cache management circuit 102 allocates the clean way 120(0)-120(C) as the target way 120(0)-120(C) for the new DRAM cache line 118(0)-118(B), 118′(0)-118′(B) (block 424). The DRAM cache management circuit 102 next writes the evicted data 136 to the new DRAM cache line 118(0)-118(B), 118′(0)-118′(B) in the target way 120(0)-120(C) (block 434). One or more valid bits 124(0)-124(I) in the tag directory 106 of the DRAM cache 104 are then updated (block 436). The DRAM cache management circuit 102 also updates one or more valid bits 148(0)-148(J) for one or more tags 146(0)-146(J) of the target way 120(0)-120(C) in the tag directory cache directory 140 (block 438). The DRAM cache management circuit 102 writes a tag 146(0)-146(J) for the new DRAM cache line 118(0)-118(B), 118′(0)-118′(B) to the tag directory cache directory 140 (block 440). Finally, the DRAM cache management circuit 102 updates a tag 122(0)-122(I) for the new DRAM cache line 118(0)-118(B), 118′(0)-118′(B) in the tag directory 106 of the DRAM cache 104 (block 442).

Turning to FIG. 4E, the operations of block 410 of FIG. 4B for writing the evicted data 136 to the DRAM cache 104 continue. In FIG. 4E, the DRAM cache management circuit 102 selects a dirty way 120(0)-120(C) within the DRAM cache 104 (block 426). The dirty way 120(0)-120(C) is then allocated as the target way 120(0)-120(C) for the new DRAM cache line 118(0)-118(B), 118′(0)-118′(B) (block 444). The DRAM cache management circuit 102 writes each dirty DRAM cache line 118(0)-118(B), 118′(0)-118′(B) within the target way 120(0)-120(C) to the system memory DRAM 110 (block 446). Processing then resumes at block 434 of FIG. 4D.

FIGS. 5A-5D are provided to illustrate exemplary operations for installing tag directory cache lines 142(0)-142(A), 142′(0)-142′(A) in the tag directory cache 138. For the sake of clarity, elements of FIG. 1 are referenced in describing FIGS. 5A-5D. In FIG. 5A, operations begin with the DRAM cache management circuit 102 determining whether an invalid way 144(0)-144(C) exists within the tag directory cache 138 (block 500). If so, processing resumes at block 502 of FIG. 5B. However, if no invalid way 144(0)-144(C) exists within the tag directory cache 138, the DRAM cache management circuit 102 next determines whether a clean way 144(0)-144(C) exists within the tag directory cache 138 (block 504). If so, processing resumes at block 506 of FIG. 5C. If no clean way 144(0)-144(C) exists within the tag directory cache 138, processing resumes at block 508 of FIG. 5D.

Referring now to FIG. 5B, the DRAM cache management circuit 102 first allocates the invalid way 144(0)-144(C) as a target way 144(0)-144(C) for the new tag directory cache line 142(0)-142(A), 142′(0)-142′(A) (block 502). The DRAM cache management circuit 102 next writes the new tag directory cache line 142(0)-142(A), 142′(0)-142′(A) to the target way 144(0)-144(C) (block 510). The DRAM cache management circuit 102 updates one or more valid bits 148(0)-148(J) for the new tag directory cache line 142(0)-142(A), 142′(0)-142′(A) in the tag directory cache directory 140 (block 512). The DRAM cache management circuit 102 then writes a tag 146(0)-146(J) for the new tag directory cache line 142(0)-142(A), 142′(0)-142′(A) to the tag directory cache directory 140 (block 514)

Turning to FIG. 5C, the DRAM cache management circuit 102 allocates the clean way 144(0)-144(C) as a target way 144(0)-144(C) for the new tag directory cache line 142(0)-142(A), 142′(0)-142′(A) (block 506). The DRAM cache management circuit 102 then updates one or more valid bits 124(0)-124(I) in the tag directory 106 of the DRAM cache 104 for one or more tags 146(0)-146(J) of the target way 144(0)-144(C) (block 516). The DRAM cache management circuit 102 also updates the one or more tags 122(0)-122(I) of the target way 144(0)-144(C) in the tag directory 106 of the DRAM cache 104 (block 518). Processing then resumes at block 510 of FIG. 5B.

In FIG. 5D, the DRAM cache management circuit 102 selects a dirty way 144(0)-144(C) within the tag directory cache 138 (block 508). The dirty way 144(0)-144(C) is allocated by the DRAM cache management circuit 102 as a target way 144(0)-144(C) for the new tag directory cache line 142(0)-142(A), 142′(0)-142′(A) (block 520). The DRAM cache management circuit 102 then writes each dirty tag directory cache line 142(0)-142(A), 142′(0)-142′(A) within the target way 144(0)-144(C) to the system memory DRAM 110 (block 522). Processing then resumes at block 516 of FIG. 5C.

Providing scalable DRAM cache management using tag directory caches according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a smart phone, a tablet, a phablet, a server, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

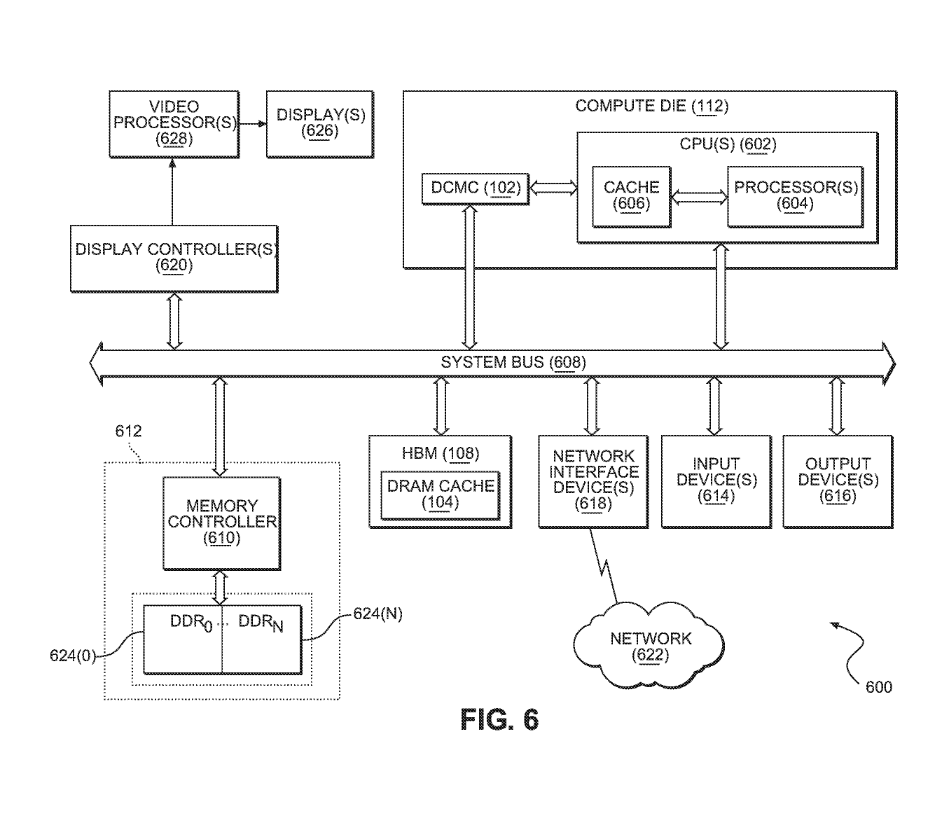

In this regard, FIG. 6 illustrates an example of a processor-based system 600 that can employ the DRAM cache management circuit (DCMC) 102 illustrated in FIG. 1 for managing the DRAM cache 104 that is part of the high-bandwidth memory (HBM) 108. The processor-based system 600 includes the compute die 112 of FIG. 1, on which one or more CPUs 602, each including one or more processors 604, are provided. The CPU(s) 602 may have cache memory 606 coupled to the processor(s) 604 for rapid access to temporarily stored data. The CPU(s) 602 is coupled to a system bus 608 and can intercouple master and slave devices included in the processor-based system 600. As is well known, the CPU(s) 602 communicates with these other devices by exchanging address, control, and data information over the system bus 608. For example, the CPU(s) 602 can communicate bus transaction requests to a memory controller 610 as an example of a slave device.

Other master and slave devices can be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including but not limited to input keys, switches, voice processors, etc. The output device(s) 616 can include any type of output device, including, but not limited to, audio, video, other visual indicators, etc. The network interface device(s) 618 can be any devices configured to allow exchange of data to and from a network 622. The network 622 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 618 can be configured to support any type of communications protocol desired. The memory system 612 can include one or more memory units 624(0)-624(N).

The CPU(s) 602 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A dynamic random access memory (DRAM) cache management circuit, communicatively coupled to a DRAM cache that is part of a high-bandwidth memory and is further communicatively coupled to a system memory DRAM;
the DRAM cache management circuit comprising:
a tag directory cache configured to cache a plurality of tags of a tag directory of the DRAM cache; and
a tag directory cache directory, configured to store a plurality of tags of the tag directory cache;
the DRAM cache management circuit configured to:
receive a memory read request comprising a read address;
determine whether the read address is found in the tag directory cache directory;
responsive to determining that the read address is not found in the tag directory cache directory, read data at the read address in the system memory DRAM; and
responsive to determining that the read address is found in the tag directory cache directory:
determine, based on the tag directory cache, whether the read address is found in the DRAM cache;
responsive to determining that the read address is not found in the DRAM cache, read data at the read address in the system memory DRAM; and
responsive to determining that the read address is found in the DRAM cache, read data for the read address from the DRAM cache.

2. The DRAM cache management circuit of claim 1, further configured to, responsive to determining that the read address is found in the DRAM cache, determine whether the data for the read address in the DRAM cache is clean;
wherein the DRAM cache management circuit is configured to read the data for the read address from the DRAM cache further responsive to determining that the data for the read address in the DRAM cache is not clean.

3. The DRAM cache management circuit of claim 2, further configured to, responsive to determining that the data for the read address in the DRAM cache is clean:
identify, based on a load balancing circuit of the DRAM cache management circuit, a preferred data source from among the DRAM cache and the system memory DRAM;
responsive to identifying the DRAM cache as the preferred data source, read data from the DRAM cache; and
responsive to identifying the system memory DRAM as the preferred data source, read data from the system memory DRAM.

4. The DRAM cache management circuit of claim 1, configured to operate in a write-through mode, and further configured to, responsive to determining that the read address is found in the DRAM cache:
identify, based on a load balancing circuit of the DRAM cache management circuit, a preferred data source from among the DRAM cache and the system memory DRAM; and
responsive to identifying the system memory DRAM as the preferred data source, read data from the system memory DRAM;
wherein the DRAM cache management circuit is configured to read the data for the read address from the DRAM cache further responsive to determining that the data for the read address in the DRAM cache is clean, and identifying the DRAM cache as the preferred data source.

5. The DRAM cache management circuit of claim 1, wherein:
the DRAM cache management circuit is further coupled to a system cache; and
the DRAM cache management circuit is configured to receive the memory read request comprising the read address responsive to a miss on the system cache.

6. The DRAM cache management circuit of claim 1, configured to probabilistically replenish the tag directory cache in parallel with reading the data at the read address in the system memory DRAM.

7. The DRAM cache management circuit of claim 6, configured to probabilistically replenish the tag directory cache by being configured to:
read data for a new tag directory cache line from the tag directory of the DRAM cache; and
install the new tag directory cache line in the tag directory cache.

8. The DRAM cache management circuit of claim 7, configured to install the new tag directory cache line in the tag directory cache by being configured to:
determine whether an invalid way exists within the tag directory cache; and
responsive to determining that an invalid way exists within the tag directory cache:
allocate the invalid way as a target way for the new tag directory cache line;
write the new tag directory cache line to the target way;
update one or more valid bits for the new tag directory cache line in the tag directory cache directory; and
write a tag for the new tag directory cache line to the tag directory cache directory.

9. The DRAM cache management circuit of claim 8, configured to install the new tag directory cache line in the tag directory cache by being further configured to, responsive to determining that an invalid way does not exist within the tag directory cache:
determine whether a clean way exists within the tag directory cache; and
responsive to determining that a clean way exists within the tag directory cache:
allocate the clean way as a target way for the new tag directory cache line;
update one or more valid bits in the tag directory of the DRAM cache for one or more tags of the target way;
update the one or more tags of the target way in the tag directory of the DRAM cache;
write the new tag directory cache line to the target way;
update one or more valid bits in the tag directory cache directory for the new tag directory cache line; and
write a tag for the new tag directory cache line to the tag directory cache directory.

10. The DRAM cache management circuit of claim 9, configured to install the new tag directory cache line in the tag directory cache by being further configured to, responsive to determining that a clean way does not exist within the tag directory cache:
select a dirty way within the tag directory cache;
allocate the dirty way as a target way for the new tag directory cache line;
write each dirty DRAM cache line within the target way to the system memory DRAM;
update one or more valid bits in the tag directory of the DRAM cache for one or more tags of the target way;
update the one or more tags of the target way in the tag directory of the DRAM cache;
write the new tag directory cache line to the target way;
update one or more valid bits in the tag directory cache directory for the new tag directory cache line; and
write a tag for the new tag directory cache line to the tag directory cache directory.

11. The DRAM cache management circuit of claim 1, further configured to:
receive, from a system cache, a memory write request comprising a write address and write data comprising clean evicted data;
determine whether the write address is found in the tag directory cache directory;
responsive to determining that the write address is found in the tag directory cache directory:
determine, based on the tag directory cache, whether the write address is found in the DRAM cache; and
responsive to determining that the write address is not found in the DRAM cache, write the clean evicted data to the DRAM cache; and
responsive to determining that the write address is not found in the tag directory cache directory:
retrieve a new tag directory cache line from the tag directory of the DRAM cache corresponding to a cache line in which a tag for the write address would be stored in the tag directory of the DRAM cache; and
install the new tag directory cache line in the tag directory cache.

12. The DRAM cache management circuit of claim 11, configured to, responsive to determining that the write address is not found in the DRAM cache, write the clean evicted data to the DRAM cache by being configured to:
determine whether an invalid way exists within the DRAM cache; and
responsive to determining that an invalid way exists within the DRAM cache:
allocate the invalid way as a target way for a new DRAM cache line;
write the clean evicted data to the new DRAM cache line in the target way;
update one or more valid bits in the tag directory cache directory for the new DRAM cache line to indicate that the new DRAM cache line is valid; and
update a tag for the new DRAM cache line in the tag directory of the DRAM cache.

13. The DRAM cache management circuit of claim 12, configured to, responsive to determining that the write address is not found in the DRAM cache, write the clean evicted data to the DRAM cache by being further configured to, responsive to determining that an invalid way does not exist within the DRAM cache:
determine whether a clean way exists within the DRAM cache; and
responsive to determining that a clean way exists within the DRAM cache:
allocate the clean way as the target way for the new DRAM cache line;
write the clean evicted data to the new DRAM cache line in the target way;
update one or more valid bits in the tag directory of the DRAM cache;
update a valid bit for one or more tags of the target way in the tag directory cache directory;
write a tag for the new DRAM cache line to the tag directory cache directory; and
update a tag for the new DRAM cache line in the tag directory of the DRAM cache.

14. The DRAM cache management circuit of claim 13, configured to, responsive to determining that the write address is not found in the DRAM cache, write the clean evicted data to the DRAM cache by being further configured to, responsive to determining that a clean way does not exist within the tag directory cache:
select a dirty way within the DRAM cache;
allocate the dirty way as the target way for the new DRAM cache line;
write each dirty DRAM cache line within the target way to the system memory DRAM;
write the clean evicted data to the new DRAM cache line in the target way;
update one or more valid bits in the tag directory of the DRAM cache;
update a valid indicator for one or more tags of the target way in the tag directory cache;
write a tag for the new DRAM cache line to the tag directory cache directory; and
update a tag for the new DRAM cache line in the tag directory of the DRAM cache.

15. The DRAM cache management circuit of claim 1, configured to operate in a write-back mode, and further configured to:
receive, from a system cache, a memory write request comprising a write address and write data comprising dirty evicted data;
determine whether the write address is found in the tag directory cache directory;
responsive to determining that the write address is found in the tag directory cache directory:
determine, based on the tag directory cache, whether the write address is found in the DRAM cache;
responsive to determining that the write address is found in the DRAM cache:
set a dirty bit for the write address in the tag directory cache directory; and
write the dirty evicted data to a DRAM cache line for the write address in the DRAM cache; and
responsive to determining that the write address is not found in the DRAM cache, write the dirty evicted data to the DRAM cache; and
responsive to determining that the write address is not found in the tag directory cache directory:
retrieve data for a new tag directory cache line from the tag directory of the DRAM cache in which a tag for the write address would be stored in the tag directory of the DRAM cache; and
install the new tag directory cache line in the tag directory cache.

16. The DRAM cache management circuit of claim 15, configured to, responsive to determining that the write address is not found in the DRAM cache, write the dirty evicted data to the DRAM cache by being configured to:
determine whether an invalid way exists within the DRAM cache; and
responsive to determining that an invalid way exists within the DRAM cache:
allocate the invalid way as a target way for a new DRAM cache line;
write the dirty evicted data to the new DRAM cache line in the target way;
update one or more valid bits in the tag directory cache directory for the new DRAM cache line to indicate that the DRAM cache line is valid; and
update a tag for the new DRAM cache line in the tag directory of the DRAM cache.

17. The DRAM cache management circuit of claim 16, configured to, responsive to determining that the write address is not found in the DRAM cache, write the dirty evicted data to the DRAM cache by being further configured to, responsive to determining that an invalid way does not exist within the DRAM cache:
determine whether a clean way exists within the DRAM cache; and
responsive to determining that a clean way exists within the DRAM cache:
allocate the clean way as the target way for the new DRAM cache line;
write the dirty evicted data for the new DRAM cache line to the target way;
update one or more valid bits in the tag directory of the DRAM cache;
update a valid bit for one or more tags of the target way in the tag directory cache directory;
write a tag for the new DRAM cache line to the tag directory cache directory; and
update a tag for the new DRAM cache line in the tag directory of the DRAM cache.

18. The DRAM cache management circuit of claim 17, configured to, responsive to determining that the write address is not found in the DRAM cache, write the dirty evicted data to the DRAM cache by being further configured to, responsive to determining that a clean way does not exist within the tag directory cache:
select a dirty way within the DRAM cache;
allocate the dirty way as the target way for the new DRAM cache line;
write each dirty DRAM cache line within the target way to the system memory DRAM;
write the dirty evicted data to the new DRAM cache line in the target way;
update one or more valid bits in the tag directory of the DRAM cache;
update a valid indicator for one or more tags of the target way in the tag directory cache;
write a tag for the new DRAM cache line to the tag directory cache directory; and
update a tag for the new DRAM cache line in the tag directory of the DRAM cache.

19. The DRAM cache management circuit of claim 1 integrated into an integrated circuit (IC).

20. The DRAM cache management circuit of claim 1 integrated into a device selected from the group consisting of: a set top box; an entertainment unit; a navigation device; a communications device; a fixed location data unit; a mobile location data unit; a mobile phone; a cellular phone; a smart phone; a tablet; a phablet; a server; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

21. A method for providing scalable dynamic random access memory (DRAM) cache management, comprising:
receiving, by a DRAM cache management circuit, a memory read request comprising a read address;
determining whether the read address is found in a tag directory cache directory of a tag directory cache of the DRAM cache management circuit;
responsive to determining that the read address is not found in the tag directory cache directory, read data at the read address in a system memory DRAM; and
responsive to determining that the read address is found in the tag directory cache directory:
determining, based on the tag directory cache, whether the read address is found in a DRAM cache that is part of a high-bandwidth memory;
responsive to determining that the read address is not found in the DRAM cache, reading data at the read address in the system memory DRAM; and
responsive to determining that the read address is found in the DRAM cache, reading data for the read address from the DRAM cache.

22. The method of claim 21, further comprising, responsive to determining that the read address is found in the DRAM cache, determining whether the data for the read address in the DRAM cache is clean;
wherein reading the data for the read address from the DRAM cache is further responsive to determining that the data for the read address in the DRAM cache is not clean.

23. The method of claim 22, further comprising, responsive to determining that the data for the read address in the DRAM cache is clean:
identifying a preferred data source from among the DRAM cache and the system memory DRAM;
responsive to identifying the DRAM cache as the preferred data source, reading data from the DRAM cache; and
responsive to identifying the system memory DRAM as the preferred data source, reading data from the system memory DRAM.

24. The method of claim 21, wherein:
the DRAM cache management circuit is configured to operate in a write-through mode; and
the method further comprises, responsive to determining that the read address is found in the DRAM cache:
identifying a preferred data source from among the DRAM cache and the system memory DRAM; and
responsive to identifying the system memory DRAM as the preferred data source, reading data from the system memory DRAM; and
reading the data for the read address from the DRAM cache is further responsive to determining that the data for the read address in the DRAM cache is clean and identifying the DRAM cache as the preferred data source.

25. The method of claim 21, wherein:
the DRAM cache management circuit is coupled to a system cache; and
receiving the memory read request comprising the read address is responsive to a miss on the system cache.

26. The method of claim 21, further comprising probabilistically replenishing the tag directory cache in parallel with reading the data at the read address in the system memory DRAM.

27. The method of claim 26, wherein probabilistically replenishing the tag directory cache comprises:
reading data for a new tag directory cache line from the tag directory of the DRAM cache; and
installing the new tag directory cache line in the tag directory cache.

28. The method of claim 27, wherein installing the new tag directory cache line in the tag directory cache comprises:
determining whether an invalid way exists within the tag directory cache; and
responsive to determining that an invalid way exists within the tag directory cache:
allocating the invalid way as a target way for the new tag directory cache line;
writing the new tag directory cache line to the target way;
updating one or more valid bits for the new tag directory cache line in the tag directory cache directory; and
writing a tag for the new tag directory cache line to the tag directory cache directory.

29. The method of claim 28, wherein installing the new tag directory cache line in the tag directory cache further comprises, responsive to determining that an invalid way does not exist within the tag directory cache:
determining whether a clean way exists within the tag directory cache; and
responsive to determining that a clean way exists within the tag directory cache:
allocating the clean way as a target way for the new tag directory cache line;
updating one or more valid bits in the tag directory of the DRAM cache for one or more tags of the target way;
updating the one or more tags of the target way in the tag directory of the DRAM cache;
writing the new tag directory cache line to the target way;
updating one or more valid bits in the tag directory cache directory for the new tag directory cache line; and
writing a tag for the new tag directory cache line to the tag directory cache directory.

30. The method of claim 29, wherein installing the new tag directory cache line in the tag directory cache further comprises, responsive to determining that a clean way does not exist within the tag directory cache:
selecting a dirty way within the tag directory cache;
allocating the dirty way as a target way for the new tag directory cache line;
writing each dirty DRAM cache line within the target way to the system memory DRAM;
updating one or more valid bits in the tag directory of the DRAM cache for one or more tags of the target way;
updating the one or more tags of the target way in the tag directory of the DRAM cache;
writing the new tag directory cache line to the target way;
updating one or more valid bits in the tag directory cache directory for the new tag directory cache line; and
writing a tag for the new tag directory cache line to the tag directory cache directory.

31. The method of claim 21, further comprising:
receiving, from a system cache, a memory write request comprising a write address and write data comprising clean evicted data;
determining whether the write address is found in the tag directory cache directory;
responsive to determining that the write address is found in the tag directory cache directory:
determining, based on the tag directory cache, whether the write address is found in the DRAM cache; and
responsive to determining that the write address is not found in the DRAM cache, writing the clean evicted data to the DRAM cache; and
responsive to determining that the write address is not found in the tag directory cache directory:
retrieving data for a new tag directory cache line from the tag directory of the DRAM cache in which a tag for the write address would be stored in the tag directory of the DRAM cache; and
installing the new tag directory cache line in the tag directory cache.

32. The method of claim 31, wherein writing the clean evicted data to the DRAM cache responsive to determining that the write address is not found in the DRAM cache comprises:
determining whether an invalid way exists within the DRAM cache; and
responsive to determining that an invalid way exists within the DRAM cache:
allocating the invalid way as a target way for a new DRAM cache line;
writing the clean evicted data to the new DRAM cache line in the target way;
updating one or more valid bits in the tag directory cache directory for the new DRAM cache line to indicate that the new DRAM cache line is valid; and
updating a tag for the new DRAM cache line in the tag directory of the DRAM cache.

33. The method of claim 32, wherein writing the clean evicted data to the DRAM cache responsive to determining that the write address is not found in the DRAM cache further comprises, responsive to determining that an invalid way does not exist within the DRAM cache:
determining whether a clean way exists within the DRAM cache; and
responsive to determining that a clean way exists within the DRAM cache:
allocating the clean way as the target way for the new DRAM cache line;
writing the clean evicted data to the new DRAM cache line in the target way;
updating one or more valid bits in the tag directory of the DRAM cache;
updating a valid bit for one or more tags of the target way in the tag directory cache directory;
writing a tag for the new DRAM cache line to the tag directory cache directory; and
updating a tag for the new DRAM cache line in the tag directory of the DRAM cache.

34. The method of claim 33, wherein writing the clean evicted data to the DRAM cache responsive to determining that the write address is not found in the DRAM cache further comprises, responsive to determining that a clean way does not exist within the tag directory cache:
selecting a dirty way within the tag directory cache;
allocating the dirty way as the target way for the new tag directory cache line;
writing each dirty DRAM cache line within the target way to the system memory DRAM;
writing the clean evicted data to the new DRAM cache line in the target way;
updating one or more valid bits in the tag directory of the DRAM cache;
updating a valid indicator for one or more tags of the target way in the tag directory cache;
writing a tag for the new DRAM cache line to the tag directory cache directory; and
updating a tag for the new DRAM cache line in the tag directory of the DRAM cache.

35. The method of claim 21, wherein:
the DRAM cache management circuit is configured to operate in a write-back mode; and
the method further comprises:
receiving, from a system cache, a memory write request comprising a write address and write data comprising dirty evicted data;
determining whether the write address is found in the tag directory cache directory;
responsive to determining that the write address is found in the tag directory cache directory:
determining, based on the tag directory cache, whether the write address is found in the DRAM cache; and
responsive to determining that the write address is found in the DRAM cache:
setting a dirty bit for the write address in the tag directory cache directory; and
writing the dirty evicted data to a DRAM cache line for the write address in the DRAM cache; and
responsive to determining that the write address is not found in the DRAM cache, writing the write data to the DRAM cache; and
responsive to determining that the write address is not found in the tag directory cache directory:
retrieving data for a new tag directory cache line from the tag directory of the DRAM cache in which a tag for the write address would be stored in the tag directory of the DRAM cache; and
installing the new tag directory cache line in the tag directory cache.

36. The method of claim 35, wherein writing the dirty evicted data to the DRAM cache responsive to determining that the write address is not found in the DRAM cache comprises:
determining whether an invalid way exists within the DRAM cache; and
responsive to determining that an invalid way exists within the DRAM cache:
allocating the invalid way as a target way for a new DRAM cache line;
writing the dirty evicted data to the new DRAM cache line in the target way;
updating one or more valid bits in the tag directory cache directory for the new DRAM cache line to indicate that the DRAM cache line is valid; and
updating a tag for the new DRAM cache line in the tag directory of the DRAM cache.

37. The method of claim 36, wherein writing the dirty evicted data to the DRAM cache responsive to determining that the write address is not found in the DRAM cache further comprises, responsive to determining that an invalid way does not exist within the DRAM cache:
determining whether a clean way exists within the DRAM cache; and
responsive to determining that a clean way exists within the DRAM cache:
allocating the clean way as a target way for the new DRAM cache line;
writing the dirty evicted data for the new DRAM cache line to the target way;
updating one or more valid bits in the tag directory of the DRAM cache;
updating a valid bit for one or more tags of the target way in the tag directory cache directory;
writing a tag for the new DRAM cache line to the tag directory cache directory; and
updating a tag for the new DRAM cache line in the tag directory of the DRAM cache.

38. The method of claim 37, wherein writing the dirty evicted data to the DRAM cache responsive to determining that the write address is not found in the DRAM cache further comprises, responsive to determining that a clean way does not exist within the tag directory cache:
selecting a dirty way within the tag directory cache;
allocating the dirty way as the target way for the new tag directory cache line;
writing each dirty DRAM cache line within the target way to the system memory DRAM;
writing the dirty evicted data to the new DRAM cache line in the target way;
updating one or more valid bits in the tag directory of the DRAM cache;
updating a valid indicator for one or more tags of the target way in the tag directory cache;
writing a tag for the new DRAM cache line to the tag directory cache directory; and
updating a tag for the new DRAM cache line in the tag directory of the DRAM cache.

39. A dynamic random access memory (DRAM) cache management circuit, comprising:
means for receiving a memory read request comprising a read address;
means for determining whether the read address is found in a tag directory cache directory of a tag directory cache of the DRAM cache management circuit;
means for reading data at the read address in a system memory DRAM, responsive to determining that the read address is not found in the tag directory cache directory;
means for determining, based on the tag directory cache, whether the read address is found in a DRAM cache that is part of a high-bandwidth memory, responsive to determining that the read address is found in the tag directory cache directory;
means for reading data at the read address in the system memory DRAM, responsive to determining that the read address is not found in the DRAM cache; and
means for reading data for the read address from the DRAM cache, responsive to determining that the read address is found in the DRAM cache.
